(19) United States
(12) Patent Application Publication
(10) Pub. No.: US 2018/0216267 A1
(43) Pub. Date: Aug. 2, 2018

(54) NONWOVEN DOWN BATTING

(71) Applicant: PRIMALOFT, INC., Latham, NY (US)

(72) Inventors: Vanessa MASON, Rexford, NY (US); Jon-Alan MINEHARDT, Clifton Park, NY (US)

(73) Assignee: PRIMALOFT, INC., Latham, NY (US)

(21) Appl. No.: 15/747,371

(22) PCT Filed: Aug. 2, 2016
(86) PCT No.: PCT/US2016/045168

§ 371 Date: Jan. 24, 2018

Related U.S. Application Data
(60) Provisional application No. 62/202,435, filed on Aug. 7, 2015.

(51) Int. Cl. D04H 1/4374; D04H 1/435; D04H 1/488; B32B 5/02; B32B 5/26; B32B 37/06

(52) U.S. Cl. CPC D04H 1/4374; D04H 1/435; D04H 1/488; B32B 5/028; B32B 5/26; D10B 2503/06; B32B 37/06; B32B 2262/0276; B32B 2437/00; D10B 2331/04; D10B 2501/04; B32B 5/022

(57) ABSTRACT

The invention provides batting that includes a nonwoven web having a first surface parallel to a second surface. The nonwoven web is made up of a fiber mixture that includes: 25 to 75 wt % spiral-crimped siliconized synthetic polymeric fibers having a denier of greater than 4 denier and less than 10 denier; and 20 to 75 wt % down treated with a durable water repellant, said down having a fill power of at least 550 in³/oz, and having a down cluster content of at least 85 wt %. Articles comprising the batting and methods of making the batting are also provided.

### CROSS REFERENCE TO RELATED APPLICATIONS

This application claims priority to U.S. Provisional Application No. 62/202,435, filed on Aug. 7, 2015, the entire contents of which are hereby incorporated herein by reference.

### FIELD OF THE INVENTION

The present invention generally relates to nonwoven down batting, to articles comprising the batting, and to methods of making the batting.

### BACKGROUND OF THE INVENTION

Down is recognized within the textile industry for providing articles within which it is employed with high quality loft and insulative properties. Typically, however, filling articles with down is tedious and costly. This is because of, inter alia, the comparative expense of down (in particular, high quality down) as compared to other alternative fibers, and difficulties that inhere to down processing. Indeed, because of its light, fluffy, and delicate nature, down is difficult to work with, and its structural integrity (to which its insulative properties are attributable) can be easily destroyed. Therefore, acceptable processing techniques for down are known within the industry to be severely limited.

Many efforts have been undertaken to try to avoid the problems inherent to down filling, including, for example, experimentation with synthetic down alternatives that are more conducive to facile and efficient insulation processing and preparations.

Unfortunately, many attempts at avoiding the high costs and other pitfalls of working with down have resulted in inferior (e.g., in terms of thermal properties), albeit at times more economical, products. Thus, a need exists for improved down products that offer the high quality insulative properties that down is known for, yet avoid drawbacks (e.g., processing drawbacks) associated with down.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

Briefly, the present invention satisfies the need for improved down-based insulative material. The present invention may address one or more of the problems and deficiencies of the art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In a first aspect, the invention provides batting comprising a nonwoven web having a first surface parallel to a second surface, said nonwoven web comprising a fiber mixture comprising:
25 to 75 wt % spiral-crimped siliconized synthetic polymeric fibers having a denier of greater than 4 denier and less than 10 denier; and
20 to 75 wt % down treated with a durable water repellant, said down having a fill power of at least 550 in³/oz, and having a down cluster content of at least 85 wt %.

In a second aspect, the invention provides an article comprising the inventive batting.

In a third aspect, the invention provides a method of making the inventive batting, said method comprising:
preparing the fiber mixture;
forming a nonwoven web from the fiber mixture; and
heating the nonwoven web.

Certain embodiments of the presently-disclosed batting, articles comprising the batting, and methods for forming the batting have several features, no single one of which is solely responsible for their desirable attributes. Without limiting the scope of the batting, articles and methods as defined by the claims that follow, their more prominent features will now be discussed briefly. After considering this discussion, and particularly after reading the section of this specification entitled “Detailed Description of the Invention,” one will understand how the features of the various embodiments disclosed herein provide a number of advantages over the current state of the art. For example, the inventive batting provides nonwoven down-based insulation characterized by high thermal efficiency and easier use in downstream garment making processes than typical (e.g., blowable) down and other commercially available down-based products. Embodiments also allow for lower garment making costs and greater flexibility regarding garment design aesthetics.

These and other features and advantages of this invention will become apparent from the following detailed description of the various aspects of the invention taken in conjunction with the appended claims and the accompanying drawings.

### BRIEF DESCRIPTION OF THE DRAWINGS

The present invention will hereinafter be described in conjunction with the following drawing figures, wherein like numerals denote like elements, and:

FIGS. 1A and 1B are photos of down clusters used in embodiments of the invention.

FIG. 2 is a top-view photograph of a portion of an embodiment of the inventive batting.

FIG. 3 is an enlarged top-view photograph of a portion of an embodiment of the inventive batting.

FIG. 4 is a profile-view photograph of an embodiment of the inventive batting.

FIG. 5 is a photograph depicting a nonwoven web used in an embodiment of the inventive batting as it is being formed using a carding machine.

### DETAILED DESCRIPTION OF THE INVENTION

Aspects of the present invention and certain features, advantages, and details thereof, are explained more fully below with reference to the non-limiting embodiments illustrated in the accompanying drawings. Descriptions of well-known materials, fabrication tools, processing techniques, etc., are omitted so as to not unnecessarily obscure the invention in detail. It should be understood, however, that the detailed description and the specific example(s), while indicating embodiments of the invention, are given by way of illustration only, and are not by way of limitation. Various substitutions, modifications, additions and/or arrangements within the spirit and/or scope of the underlying inventive concepts will be apparent to those skilled in the art from this disclosure.

Embodiments of the inventive nonwoven down batting offer a low density, high loft, thermally efficient down insulation in a layered structure with excellent drape and compressibility characteristics suitable for use in, inter alia, cold weather clothing apparel and sleeping bags. The invention also allows for down clusters to be utilized in a layered structure, which allows for easier handling at the garment making level, thus resulting in significantly lower garment making costs. Also, quilting designs/patterns are limited in apparel when loose down fill is utilized. By offering down in a layered structured form, the freedom of design to utilize complicated quilt patterns is feasible.

In a first aspect, the invention provides batting comprising a nonwoven web having a first surface parallel to a second surface, said nonwoven web comprising a fiber mixture comprising:
25 to 75 wt % spiral-crimped siliconized synthetic polymeric fibers having a denier of greater than 4 denier and less than 10 denier; and
20 to 75 wt % down treated with a durable water repellant, said down having a fill power of at least 550 in³/oz, and having a down cluster content of at least 85 wt %.

In some embodiments, the members of the fiber mixture are homogenously mixed, meaning, the fiber mixture has a substantially uniform (i.e., 90-100% uniform) composition.

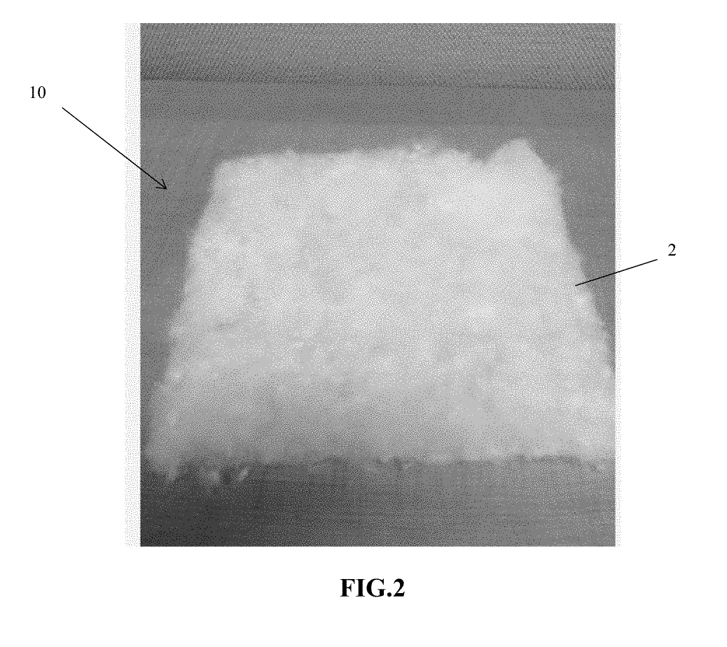

FIG. 2 is a top-view photograph of a portion of an embodiment 10 of the inventive batting. The depicted batting 10 comprises first surface 2 and second surface 4 (not pictured, but which is parallel to first surface 2, and which, in the depicted embodiment, faces the surface on which batting 10 is placed). In some embodiments, when batting 10 is contained within in an article (e.g., as insulation), first surface 2 will face toward an outer portion (e.g., fabric or other material or liner) of the article, e.g., a jacket, and second surface 4 will face toward an inner portion (e.g., fabric or other material or liner) of the article. In other embodiments, first surface 2 faces toward an inner portion of an article and second surface 4 faces toward an outer portion of an article.

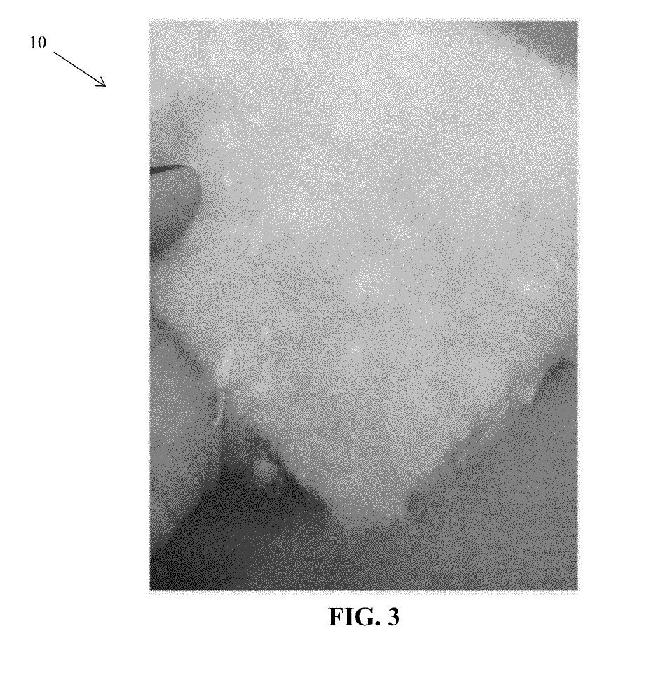

FIG. 3 is an enlarged top-view photograph of a portion of an embodiment of the inventive batting 10.

Synthetic polymeric fibers that may constitute the synthetic polymeric fibers discussed herein include any synthetic polymeric fiber known in the art as being conducive to the preparation of textile materials. Synthetic polymeric fibers that may constitute the synthetic polymeric fibers include, but are not limited to, nylon, polyester, polyamide, acrylic, acetate, polyolefin, nylon, rayon, lyocell, aramid, spandex, viscose, and modal fibers, and combinations thereof. In particular embodiments, synthetic polymeric fibers comprise polyester fibers. For example, in some embodiments, the polyester is selected from poly(ethylene terephthalate), poly(hexahydro-p-xylylene terephthalate), poly(butylene terephthalate), poly-1,4-cyclohexelyne dimethylene (PCDT) and terephthalate copolyesters in which at least 85 mole percent of the ester units are ethylene terephthalate or hexahydro-p-xylylene terephthalate units. In a particular embodiment, the polyester is polyethylene terephthalate.

Generally speaking, fibers may be crimped or uncrimped. Various crimps, including spiral and standard (e.g., planar) crimp, are known in the art.

A spiral-crimped fiber is a fiber having a spiral (i.e., helical) configuration.

The weight percent of the spiral-crimped siliconized synthetic polymeric fibers in the fiber mixture is 25 to 75 wt %, for example, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75 wt %, including any and all ranges and subranges therein (e.g., 25-30 wt %).

It has been found that, when at least 25 wt % of the spiral-crimped siliconized synthetic polymeric fibers are included in the fiber mixture, these spiral-crimped fibers advantageously function so as to capture and transport down clusters properly (e.g., through a carding machine process) without damaging the cluster structure and its thermal properties. This is quite surprising and advantageous, as down clusters are well known to be quickly and easily damaged when processed on nonwoven machinery. Indeed, persons having ordinary skill in the art would typically consider nonwoven processing of down (e.g., via carding machine) to be destructive and nonsensical. Further, it is also extremely difficult to feed and contain down clusters within nonwoven machinery. The down blows out of and escapes the confines of the machinery. The conduciveness of embodiments of the inventive batting and fiber mixture to use with conventional nonwoven processing is unexpected and is highly advantageous.

The spiral-crimped siliconized synthetic polymeric fibers are siliconized fibers. The term “siliconized” means that a component (e.g. fiber) is coated with a silicon-comprising composition (e.g., a silicone). Siliconization techniques are well known in the art, and are described, e.g., in U.S. Pat. No. 3,454,422. The silicon-comprising composition can be applied using any method known in the art, e.g., spraying, mixing, dipping, padding, etc. During siliconization, the silicon-comprising (e.g., silicone) composition, which may include an organosiloxane or polysiloxane, may bond to an exterior portion of a component (e.g., fiber). In some embodiments, the silicone coating is a polysiloxane such as a methylhydrogenpolysiloxane, modified methylhydrogenpolysiloxane, polydimethylsiloxane, or amino modified dimethylpolysiloxane. During various siliconization methods, the silicon-comprising composition may be applied directly to a component, or may be diluted with a solvent as a solution or emulsion, e.g. an aqueous emulsion of a polysiloxane, prior to application. Following treatment, the coating may be dried and/or cured. As is known in the art, a catalyst may be used to accelerate the curing of the silicon-comprising composition (e.g., polysiloxane containing Si—H bonds) and, for convenience, may be added to a silicon-comprising composition emulsion, with the resultant combination being used to treat the exterior surface of a component. Suitable catalysts include iron, cobalt, manganese, lead, zinc, and tin salts of carboxylic acids such as acetates, octanoates, naphthenates and oleates. While the above description describes some non-limiting siliconization techniques, any known siliconization techniques may be employed to prepare siliconized components as used herein. Further, there are many commercially available siliconized components (e.g., fibers), which may be purchased and used in accordance with embodiments of the invention.

Denier is a unit of measure defined as the weight in grams of 9000 meters of a yarn or fiber. It is a common way to specify the weight (or size) of yarn or fiber. For example, polyester fibers that are 1.0 denier have a diameter of approximately 10 micrometers. Micro-denier fibers are those having a denier of 1.0 or less while macro-denier fibers have a denier greater than 1.0.

The spiral-crimped siliconized synthetic polymeric fibers have a denier of greater than 4 denier and less than 10 denier (i.e., between 4 and 10 denier), including any and all ranges and subranges therein. For example, in some embodiments, the spiral-crimped siliconized synthetic polymeric fibers have a denier of 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, or 9.9 denier, including any and all ranges and subranges therein.

In some embodiments, the spiral-crimped siliconized synthetic polymeric fibers have a length (e.g., an average length of a staple cut length) of 38 to 105 mm, including any and all ranges and subranges therein. For example, in some embodiments, the length is 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, or 105 mm, including any and all ranges/subranges therein (e.g., 51-74 mm).

Fiber lengths, throughout this application, are pre-crimp measurements (i.e., the length measurement of a fiber before it is crimped).

The fiber mixture also comprises 20 to 75 wt % down treated with a durable water repellant (also referred to herein as DWR-treated down), said down having a fill power of at least 550 in³/oz, and having a down cluster content of at least 85 wt %.

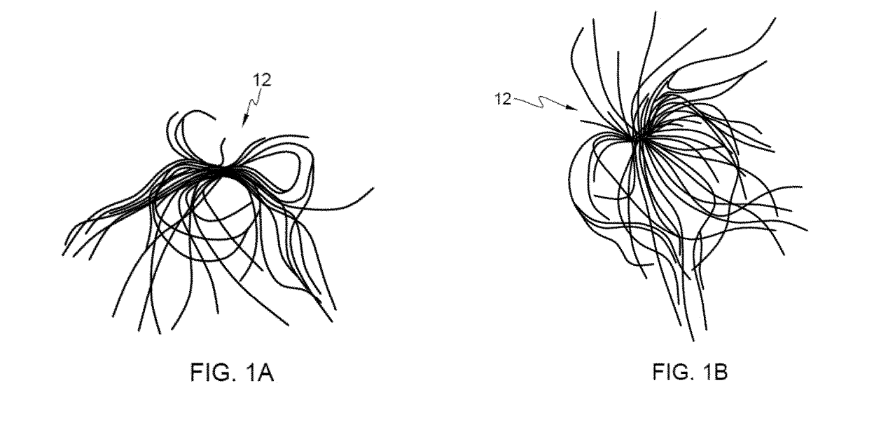

As used herein, the term “down” refers to the under plumage (i.e., the layer of insulation underneath feathers) of waterfowl (e.g., goose, duck, swan), which includes tufts of light, fluffy filaments growing from a quill point, but without any quill shaft. Down has a three dimensional structure which traps air and gives down its insulative properties. Down includes down clusters (see, e.g., down clusters 12 in FIGS. 1A and 1B) which, as is well known in the art, are soft and fluffy three-dimensional structures having barb fibers radiating from a center point.

Durable water repellant (DWR) treatments are well known in the art, and provide water repellent properties to treated components. Persons having ordinary skill in the art are familiar with a variety of DWR treatments, any of which may be used in connection with the present invention. In particular, non-limiting embodiments, the DWR-treated down is down that has been treated with a polymer solution of zirconium acetate, which can impart durable water repellant properties while minimizing and/or avoiding negative effects on fill power of the down. In some embodiments, the down treated with a durable water repellant is treated with a water-repellant, bacterial-resistant, low friction cured zirconium acetate finish, such that the down has improved driability following washing and enhanced handle and resistance to clumping. An example of a zirconium acetate solution that may be used as a DWR treatment in connection with the present invention is disclosed in U.S. Pat. No. 4,537,594. In some embodiments, the down treated with a durable water repellant is treated in a wet bath or dry spraying process. In some embodiments, the treatment comprises a surface energy modification technique, which, as is known in the art, may include, e.g., plasma treatment. Such treatments or processes are explained in U.S. Pat. No. 4,869,922, U.S. Pat. No. 5,262,208, U.S. Pat. No. 5,895,558, U.S. Pat. No. 6,416,633, U.S. Pat. No. 7,510,632, U.S. Pat. No. 8,309,033, and U.S. Pat. No. 8,298,627.

The weight percent of the DWR-treated down in the fiber mixture is 20 to 75 wt %, for example, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75 wt %, including any and all ranges and subranges therein.

As mentioned above, the DWR-treated down has a fill power of at least 550 in³/oz. Fill power is a measure of loft or “fluffiness.” The higher the fill power, the more air an ounce of the down can trap, and thus the more insulating ability an ounce of the down will have. Technically speaking, fill power is a measurement of the amount of space one ounce of down will occupy in cubic inches when allowed to reach its maximum loft. For example, one ounce of 550 fill power down will loft to 550 cubic inches.

In some embodiments, the DWR-treated down has a fill power of 550 to 900 in³/oz, for example, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, or 900 in³/oz, including any and all ranges and subranges therein (e.g., 650-750 in³/oz)

As mentioned above, the DWR-treated down has a down cluster content of at least 85 wt % (i.e., at least 85 wt % of the DWR-treated down is down clusters). The DWR-treated down may comprise 85 to 100 wt % down clusters, for example, 85, 86, 87, 88, 89, 90, 91, 92, 93, 94, 95, 96, 97, 98, 99, or 100 wt %, including any and all ranges and subranges therein (e.g., 90-95 wt %).

In some embodiments, the fiber mixture additionally comprises 5 to 25 wt % synthetic binder fibers having a denier of 1.5 to 4.0, said binder fibers having a bonding temperature lower than the softening temperature of the siliconized synthetic polymeric fibers.

In some embodiments, the synthetic binder fibers make up, e.g., 5, 6, 7, 8, 9, 10, 11, 12, 13, 14, 15, 16, 17, 18, 19, 20, 21, 22, 23, 24, or 25 wt % of the fiber mixture, including any and all ranges and subranges therein (e.g., 20-25 wt %).

In some embodiments, the synthetic binder fibers have a denier of, e.g., 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 denier, including any and all ranges and subranges therein (e.g., 2.0-2.2 denier).

In some embodiments, the binder fibers have a staple cut length of 38 to 105 mm, including any and all ranges and subranges therein. For example, in some embodiments, the length is 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, or 105 mm, including any and all ranges/subranges therein (e.g., 38-51 mm).

As indicated above, the binder fibers have a bonding temperature lower than the softening temperature of the siliconized synthetic polymeric fibers. In some embodiments, the binder fibers have a bonding temperature of less than or equal to 200° C. In some embodiments, the binder fibers have a bonding temperature of 50 to 200° C., including any and all ranges and subranges therein. In some embodiments, the binder fibers have a bonding temperature of 80° C. to 150° C. In some embodiments, the binder fibers have a bonding temperature of 100° C. to 125° C.

In some embodiments, the binder fibers comprise low-melt polyester fibers.

In some embodiments, the binder fibers are bicomponent fibers comprising a sheath and a core, wherein the sheath comprises a material having a lower melting point than the core.

The inventive batting, in some embodiments, has been heat treated so as melt all or a portion of the binder fibers, thereby forming a bonded web-type batting. Persons having ordinary skill in the art will understand that, in such embodiments, although “binder fibers” are recited in the fiber mixture of the batting, said fibers may be wholly or partially melted fibers, as opposed to binder fibers in their original, pre-heat treatment form.

In some embodiments, the fiber mixture additionally comprises one or more types of natural fibers. For example, in some embodiments, the fiber mixture additionally comprises one or more members selected from wool, cotton, tencel, flax, animal hair, silk, and down.

In particular embodiments, the fiber mixture additionally comprises down, as a separate fiber population from the DWR-treated down discussed above. For example, in some embodiments, the fiber mixture additionally comprises untreated down, e.g., 20-60 wt % (e.g., 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %) untreated down, including any and all ranges and subranges therein.

In some embodiments, the fiber mixture additionally comprises down (e.g., untreated down), and the down has a fill power of at least 550 in³/oz, for example, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, or 900 in³/oz, including any and all ranges and subranges therein.

In some embodiments, the fiber mixture additionally comprises down (e.g., untreated down), and the down has a down cluster content of 85 to 100 wt % down clusters, for example, 85, 86, 87, 88, 89, 90, 91, 92, 93, 94, 95, 96, 97, 98, 99, or 100 wt %,

In some embodiments, the average fill power of all down present in the batting is at least 550 in³/oz, for example, at least 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, or 900 in³/oz.

In some embodiments, the fiber mixture additionally comprises 1 to 30 wt % (including any and all ranges and subranges therein) non-spiral (e.g., standard-crimped) synthetic polymeric fibers. For example, in some embodiments, the fiber mixture comprises 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % non-spiral crimped synthetic polymeric fibers. In some embodiments, the non-spiral crimped synthetic polymeric fibers have a denier of less than 2.0 (e.g., 0.4, 0.5, 0.6, 0.7, 0.8, 0.9, 1.0, 1.1, 1.2, 1.3, 1.4, 1.5, 1.6, 1.7, 1.8, or 1.9 denier). The non-spiral crimped synthetic polymeric fibers, when present in the fiber mixture, are optionally siliconized. In some embodiments, the non-spiral crimped synthetic polymeric fibers have a staple cut length of 38 to 105 mm, including any and all ranges and subranges therein. For example, in some embodiments, the length is 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, or 105 mm.

In some embodiments, the first surface and/or the second surface of the non-woven web comprises a cross-linked resin. This is the case where, for instance, a cross-linker solution comprising a cross-linker compound has been applied to the first and/or second surface. The resin is a cross-linked (e.g., via heat treatment) version of the cross-linker solution. In some embodiments, the cross-linked resin comprises a cross-linker that is a cross-linked acrylate (co)polymer. In some embodiments, the cross-linker solution and/or the cross-linker compound display softness and hydrophobicity. In some embodiments, the cross-linker compound has a glass transition temperature (Tg) of less than 0° C.

In some embodiments, at least one of the first surface and second surface comprises a scrim layer. As is well known in the art, scrim is an interlining that is often used as a protective layer between insulation and a shell or liner fabric of an article. Use of binder fibers, resin, and/or scrim as discussed herein can help to mitigate fiber migration (penetration of fiber through fabric surface such that fiber is present on the face side of an article) in the inventive batting.

As discussed above, the inventive batting comprises the nonwoven web, which comprises the fiber mixture. In some embodiments, the fiber content of the nonwoven web consists of the fiber mixture.

In some embodiments, the batting comprises a single nonwoven web. In other embodiments, the batting comprises a plurality of nonwoven web layers, wherein one or more of said layers is a nonwoven web comprising the fiber mixture. In some embodiments, the batting comprises a plurality of nonwoven webs, all of which comprise the fiber mixture.

In some embodiments, the batting comprises a plurality of nonwoven web layers, which are crosslapped with one another. In some embodiments, the batting comprises a plurality of nonwoven web layers, which are crosslapped and bonded with one another.

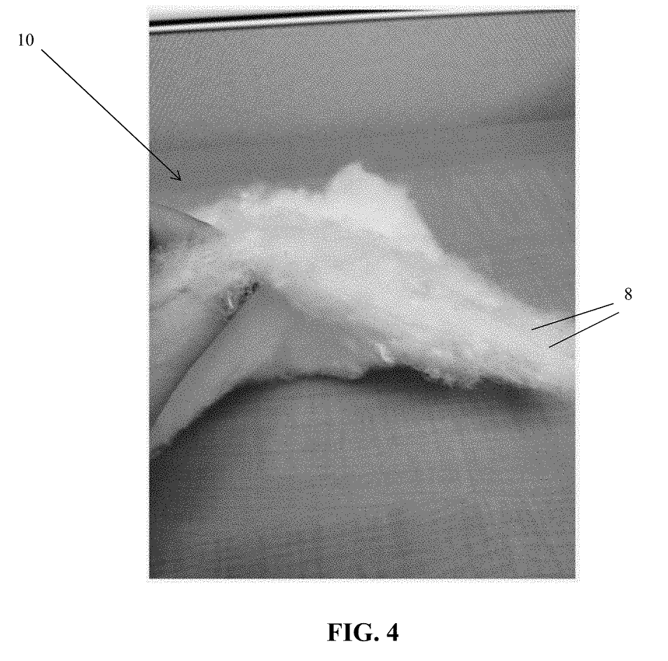

FIG. 4 is a profile-view photograph of an embodiment of the inventive batting, which comprises a plurality of nonwoven web layers 8, each comprising the fiber mixture discussed above.

Generally speaking, by adding nonwoven web layers to the batting, the thickness and insulative properties of the batting can be increased. In some embodiments, the batting has a thickness of 5 to 25 mm (e.g., 5, 6, 7, 8, 9, 10, 11, 12, 13, 14, 15, 16, 17, 18, 19, 20, 21, 22, 23, 24, or 25 mm), including any and all ranges and subranges therein (e.g., 10 to 20 mm).

In some embodiments, the batting has a density of 5 to 8 kg/m³, including any and all ranges and subranges therein. For example, in some embodiments, the batting has a density of 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, or 8.0 kg/m³.

In some embodiments, the batting has a thermal performance rating of at least 0.75 clo/oz/yd² when tested according to ISO 11092. For example, in some embodiments, the batting has a thermal performance rating of 0.75 clo/oz/yd² to 1.25 clo/oz/yd² (e.g., 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.0, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, or 1.25 clo/oz/yd²), including any and all ranges and subranges therein (e.g., 0.80 to 1.0 clo/oz/yd²). In some embodiments, the batting has a thermal performance rating of at least 0.80 clo/oz/yd² when tested according to ISO 11092.

In some embodiments, the batting has a water uptake of less than or equal to 30 wt %. As referred to herein, “water uptake” is determined according to the Hohenstein method for wet thermal performance. The Hohenstein method entails saturating an insulation sample for two minutes in room temperature distilled water and then centrifuging it for 23 seconds under a speed of 1500 revolutions per minute. This process is repeated twice before weighing the wetted sample and comparing its wetted weight to its initial dry weight for determination of the water uptake as a weighted percentage. In some embodiments, the batting has a water uptake of 10 to 30 wt %, including any and all ranges and subranges therein. For example, in some embodiments, the batting has a water uptake of 10, 11, 12, 13, 14, 15, 16, 17, 18, 19, 20, 21, 22, 23, 24, 25, 26, 27, 28, 29, or 30 wt %.

In some embodiments, the batting has a weight of 60 to 200 gsm (e.g., 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, or 200 gsm), including any and all ranges and subranges therein.

In some embodiments, the batting is in sheet form (suitable for use as a rolled good) and has not been shredded.

In a second aspect, the invention provides an article comprising the inventive batting. Non-limiting examples of such articles include, for example, outerwear (e.g. outerwear garments such as jackets, etc.), clothing, sleeping bags, bedding (e.g., comforters), etc. In some embodiments, the article is a piece of active wear (e.g., clothing, including footwear, worn for sport or physical exercise).

In a third aspect, the invention provides a method of making the inventive batting, said method comprising:
preparing the fiber mixture;
forming a nonwoven web from the fiber mixture; and
heating the nonwoven web.

In some embodiments, the invention provides a method of making the inventive batting, said method comprising:
preparing the fiber mixture;
forming a nonwoven web from the fiber mixture;
layering at least two web layers, at least one of which being the nonwoven web, thereby creating a layered batting insulation structure; and
heating the layered batting insulation structure, thereby bonding the layered batting insulation structure.

The fiber mixture can be any embodiment as described above in the first aspect of the invention.

In some embodiments where binder fiber is present in the fiber mixture, heating comprises heating the non-woven web (or layered batting insulation, where a plurality of web layers are present) to or in excess of the bonding temperature of the binder fibers.

In some embodiments, the nonwoven web is formed using a carding machine. For example, some such embodiments comprise, after preparing the fiber mixture, a non-aggressive flat top carding process.

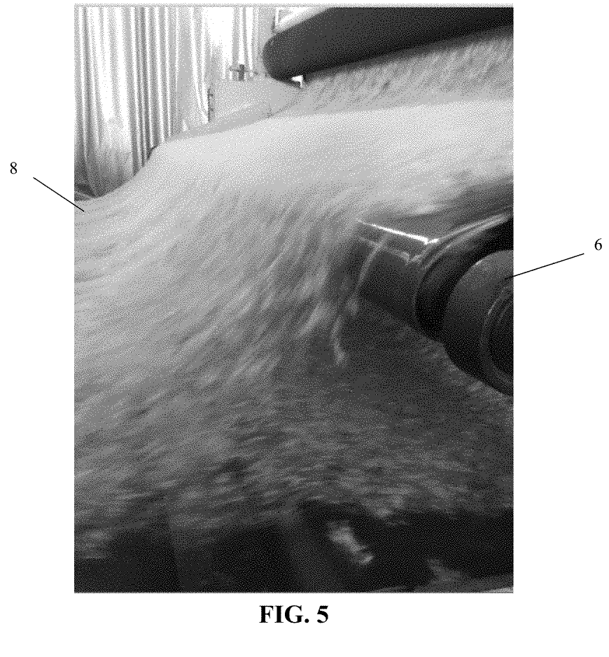

FIG. 5 is a photograph depicting a nonwoven web 8 used in an embodiment of the inventive batting as it is being formed using a carding machine 6. Nonwoven web 8 comprises the fiber mixture discussed above.

In some embodiments, for example, where the first and/or second surface comprises a cross-linked resin, the process for making the inventive batting may comprise applying a cross-linker solution to said surface(s). In some embodiments, said applying comprises spraying the solution onto the first and/or second surfaces of the nonwoven web, and wherein, during spraying, spray drops of the solution have an average median diameter of 150 to 250 μm (e.g., 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, or 250 μm), including any and all ranges and subranges therein.

In some embodiments, during said applying, spray nozzles traverse over the top and across the width of the first and second surfaces of the batting. In some embodiments, the spray nozzles maximize atomization of the cross-linker solution.

In some embodiments, the cross-linker solution, when sprayed on the first and second surfaces, is of uniform distribution and thickness.

In some embodiments, the inventive process comprises, after heating, winding the batting into roll good form. Such embodiments lend themselves toward, e.g., easy shipping of the batting. In some embodiments, the final down nonwoven insulation is wound up along with a nonwoven scrim layer and shipped in roll good form.

### EXAMPLES

The invention will now be illustrated, but not limited, by reference to the specific embodiments described in the following examples.

### Example 1

A fiber mixture is prepared by mixing the following:
25% 650 Fill Power Down (90% Cluster Minimum, 10% Feather Maximum)
25% 7.0 Denier×64 MM Siliconized Fiber with Spiral Crimp
25% 1.4 Denier×51 MM Siliconized Fiber w/Standard Crimp
25% 2.2 Denier×51 MM Low Melt Binder Fiber

After being mixed/blended, the fiber mixture is then processed into web form on a traditional flat top carding machine outfitted with a non-aggressive card wire to form a layered insulation structure. Web layers of the down nonwoven are then crosslapped so as to form a layered batting insulation structure, which is heated, thereby bonding the layered batting insulation structure, which provides stabilization for future repeated use and launderings. The insulative batting is allowed to cool, then proceeds to windup and packaging, then to incorporation into an article.

The example batting has a weight of 100 gsm (grams per square meter), a thickness of 13 mm, and a density of 7.70 kg/m³, and exhibits the following performance features:
Dry Thermals—0.83 clo/oz/sqyd
Wet Thermals—0.76 clo/oz/sqyd
Water Adsorption—30%

### Example 2

A fiber mixture is prepared by mixing the following:
50% 650 Fill Power Down (90% Cluster Minimum, 10% Feather Maximum)
30% 7.0 Denier×64 MM Siliconized Fiber with Spiral Crimp
20% 2.2 Denier×51 MM Low Melt Binder Fiber

After being mixed/blended, the fiber mixture is then processed into web form on a traditional flat top carding machine outfitted with a non-aggressive card wire to form a layered insulation structure. Web layers of the down nonwoven are then crosslapped so as to form a layered batting insulation structure, which is heated, thereby bonding the layered batting insulation structure, which provides stabilization for future repeated use and launderings. The insulative batting is allowed to cool, then proceeds to windup and packaging, then to incorporation into an article.

The example batting has a weight of 100 gsm (grams per square meter), a thickness of 16 mm, and a density of 6.25 kg/m³, and exhibits the following performance features:
Dry Thermals—0.95 clo/oz/sqyd
Wet Thermals—0.85 clo/oz/sqyd
Water Adsorption—30%

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or article that “comprises”, “has”, “includes” or “contains” one or more steps or elements possesses those one or more steps or elements, but is not limited to possessing only those one or more steps or elements. Likewise, a step of a method or an element of an article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed compositions or methods.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

1. Batting comprising a nonwoven web having a first surface parallel to a second surface, said nonwoven web comprising a fiber mixture comprising:
25 to 75 wt % spiral-crimped siliconized synthetic polymeric fibers having a denier of greater than 4 denier and less than 10 denier; and
20 to 75 wt % down treated with a durable water repellant, said down having a fill power of at least 550 in³/oz, and having a down cluster content of at least 85 wt %.

2. The batting according to claim 1, wherein the fiber mixture additionally comprises:
5 to 25 wt % synthetic binder fibers having a denier of 1.5 to 4.0, said binder fibers having a bonding temperature lower than the softening temperature of the siliconized synthetic polymeric fibers.

3. The batting according to claim 2, wherein the binder fibers have a staple cut length of 38 mm to 105 mm.

4. The batting according to claim 1, wherein at least one of the first surface and second surface comprises a cross-linked resin.

5. The batting according to claim 1, wherein at least one of the first surface and second surface comprises a scrim layer.

6. The batting according to claim 1, wherein the fiber mixture additionally comprises:
natural fibers.

7. The batting according to claim 1, wherein the fiber mixture additionally comprises:
20 to 60 wt % untreated down.

8. The batting according to claim 7, wherein said untreated down has a fill power of at least 550 in³/oz, and has a down cluster content of at least 85 wt %.

9. The batting according to claim 1, wherein the fiber mixture additionally comprises:
1 to 30 wt % standard-crimped synthetic polymeric fibers having a denier of less than 2.0.

10. (canceled)

11. The batting according to claim 9, wherein the standard-crimped synthetic polymeric fibers are siliconized.

12. (canceled)

13. The batting according to claim 9, wherein the spiral-crimped siliconized synthetic polymeric fibers have a staple cut length of 51 mm to 74 mm, and the standard-crimped synthetic polymeric fibers have a staple cut length of 38 mm to 105 mm.

14. The batting according to claim 1, wherein the spiral-crimped siliconized synthetic polymeric fibers are polyester fibers.

15. The batting according to claim 1, said batting comprising a plurality of nonwoven web layers, wherein one or more of said layers comprises the fiber mixture.

16. (canceled)

17. The batting according to claim 1, wherein the average fill power of all down present in the batting is at least 550 in³/oz.

18. (canceled)

19. The batting according to claim 1, having a density of 5 to 8 kg/m³.

20. The batting according to claim 1, having a thermal performance rating of at least 0.80 clo/oz/yd² when tested according to ISO 11092.

21. The batting according to claim 1, having a water uptake of less than or equal to 30 wt %.

22. An article comprising the batting according to claim 1.

23. The article according to claim 22, wherein said article is selected from the group consisting of an outerwear product, clothing, a sleeping bag, and bedding.

24. A method of making the batting according to claim 1, said method comprising:
preparing the fiber mixture;
forming a nonwoven web from the fiber mixture;
layering at least two web layers, at least one of which being the nonwoven web, thereby creating a layered batting insulation structure; and
heating the layered batting insulation structure, thereby bonding the layered batting insulation structure.

25. (canceled)
